(19) United States
(12) Patent Application Publication
(10) Pub. No.: US 2006/0265247 A1
(43) Pub. Date: Nov. 23, 2006

(54) Pharmacy admixture management system and method

(76) Inventor: Anthony K. Chaudhuri, Naples, FL (US)

Correspondence Address: EDWARD M. LIVINGSTON, PA, 963 TRAIL TERRACE DRIVE, NAPLES, FL, 34103, US

(21) Appl. No.: 11/436,427

(22) Filed: May 18, 2006

Related U.S. Application Data
(60) Provisional application No. 60/682,660, filed on May 19, 2005.

(51) Int. Cl. G06Q 10/00

(52) U.S. Cl. 705/2

(57) ABSTRACT

A pharmacy admixture system and method that validates the admixture preparation process by using bar code scanning to verify users of the system and components of an admixture. The system employs computers, preferably portable and wirelessly connected, with integrated non-contact bar code scanning capability to electronically validate orders, the compounding of admixtures and delivery.

This application claims the benefit of provisional patent application Ser. No. 60/682,660, filed on May 19, 2005.

### BACKGROUND OF THE INVENTION

This invention relates to medicinal management systems and methods, and more particularly, to a pharmaceutical admixture management system and method primarily for intravenous (IV) mixtures.

In a hospital or clinic setting, IV fluids are prescribed for a patient when a patient is either unable to orally receive foods, nutrients or medications or, due to time requirements, IV fluids must be pumped directly into the blood stream to quicken the processing of such items. Normally, IV fluids are of a water or sugar-water solution base with additional ingredients, such as vitamins, minerals, nutrients or medications which are mixed or added to the water solution base as prescribed by a physician.

Conventionally, when an order for an IV fluid admixture is made by a physician, the order is sent to a pharmacy to commence what is known as the “compounding” process. Pharmacy employees first review the order to determine whether the order is valid, then a pharmacist adds the appropriate components to the water or sugar-water base as necessary to fulfill the order. The order is then signed off by a pharmacist and is delivered for use to the appropriate location and patient. Unfortunately, due to various factors, including time, cost and simple human error, mistakes are common in the compounding process.

For instance, pharmacists are supposed to compound an order for an IV fluid admixture. However, due to time, cost constraints and a large scale shortage of pharmacists, technicians who generally have less training and experience, and therefore are paid less, may prepare the IV fluid using incorrect amounts of the necessary ingredients. In addition, the lesser experienced technicians may subsequently forget to add some ingredients or even use expired ingredients. Although many pharmacies have rules stating that a pharmacist must review an order prepared by the technician prior to signing off and delivery to the location and patient, it is difficult to test an IV fluid solution after the solution is mixed. Accordingly, a pharmacist may sign off on an improper admixture.

In addition, even if the mixture is prepared by a pharmacist, human error may occur in preparing the fluids, as pharmacists may also use the incorrect amounts, incorrect components, incorrect ingredients or expired ingredients.

An error in making an admixture can result in the death of a patient.

Thus, the need exists for a pharmaceutical admixture management system and method wherein the potential errors relating to compounding processes are eliminated.

### SUMMARY OF THE INVENTION

The primary object of the present invention is to provide a pharmacy IV admixture management system and method wherein potential errors relating to compounding are virtually eliminated.

Another object of the present invention is to provide a pharmacy IV admixture management system and method that is automated.

Another object of the present invention is to provide a pharmacy IV admixture management system and method that is portable.

A further object of the present invention is to provide a pharmacy IV admixture management system and method that includes several verification steps during the compound process.

An even further object of the present invention is to provide a pharmacy IV admixture management system and method that is easy to use.

Another object of the present invention is to provide a pharmacy IV admixture management system and method that is used in real-time against automatically updated system databases to ensure that all compounding is performed according to pharmacy requirements.

The present invention fulfills the above and other objects by providing a pharmacy IV admixture management system and method comprised of computers, preferably portable and wirelessly connected, with integrated non-contact bar code scanning capability to electronically validate the IV admixture preparation process.

The present invention fulfils the above and other objectives by providing a system and method for managing pharmaceutical admixing which includes verifying the validity of an order, verifying the accuracy of compounding the order and verifying the order is properly delivered to a patient. The system and method also provides for verification of compounding by a third party, such as a pharmacist in the case where a technician manufacturers the admixture. The system also provides a way to handle errors which may occur during the compounding process and provides user security for entry into the system. As described, the system and method utilizes bar codes on labels to identify orders and order components for an admixture.

The above and other objects, features and advantages of the present invention should become even more readily apparent to those skilled in the art upon a reading of the following detailed description in conjunction with the drawings wherein there is shown and described illustrative embodiments of the invention.

### BRIEF DESCRIPTION OF THE DRAWINGS

FIG. 1 is a flow chart illustrating the sign-on and mode selection phase of the pharmacy admixture system and method of the present invention;

FIG. 2 is a flow chart illustrating the compounding phase of the pharmacy admixture system and method of the present invention;

FIG. 3 is a flow chart illustrating the verification phase of the pharmacy admixture system and method of the present invention;

FIG. 4 is a flow chart illustrating the delivery out phase of the pharmacy admixture system and method of the present invention;

FIG. 5 is a flow chart illustrating the delivery in phase of the pharmacy admixture system and method of the present invention; and

FIG. 6 is a flow chart illustrating the compounding error handling phase of the pharmacy admixture system and method of the present invention.

### DESCRIPTION OF THE PREFERRED EMBODIMENT

The admixture management system and method of the present invention employs hardware which is currently available. The hardware and physical components consist of portable wireless no-ad computers with integrated non-contact bar code scanning capability to electronically validate the admixture preparation. Bar codes are used to identify both orders and order components while security features are used to ensure that only authorized users may access the system. The bar code scans are validated in real time against a database which is automatically updated so as to ensure that all compounding is performed according to pharmacy requirements. At a minimum, it is desired that the present system will ensure the following criteria:

1. Whether orders are valid;

2. Whether all the components used meet compounding requirements;

3. Whether the components are used in proper quantities;

4. Verification by technician during the production process;

5. Verification by pharmacist after verification by technician or, in the case that the pharmacist produces the order, a one-step verification by the pharmacist.

In addition, the present system includes an order status management which indicates the following:

1. Whether orders are open or unfulfilled;

2. Orders in production;

3. Production finished order verified by technician;

4. Discontinued or canceled orders;

5. Completed orders awaiting pharmacist verification;

6. Orders verified by both technician and pharmacist;

7. Orders in delivery process; and

8. Delivered orders.

All events in the system occur in real time so that instant status updates may be obtained at any time regarding any and all orders by type, production status, verification status or delivery status. All data records are marked with the user ID, the date and time and identification (ID) of the portable data acquisition device (PDAD) used in the process. Also, date of entry records are marked to identify whether data was scanned or entered manually on the PDAD.

Having briefly described the hardware used in operating the system, a more detailed description is provided by reference to the drawing figures.

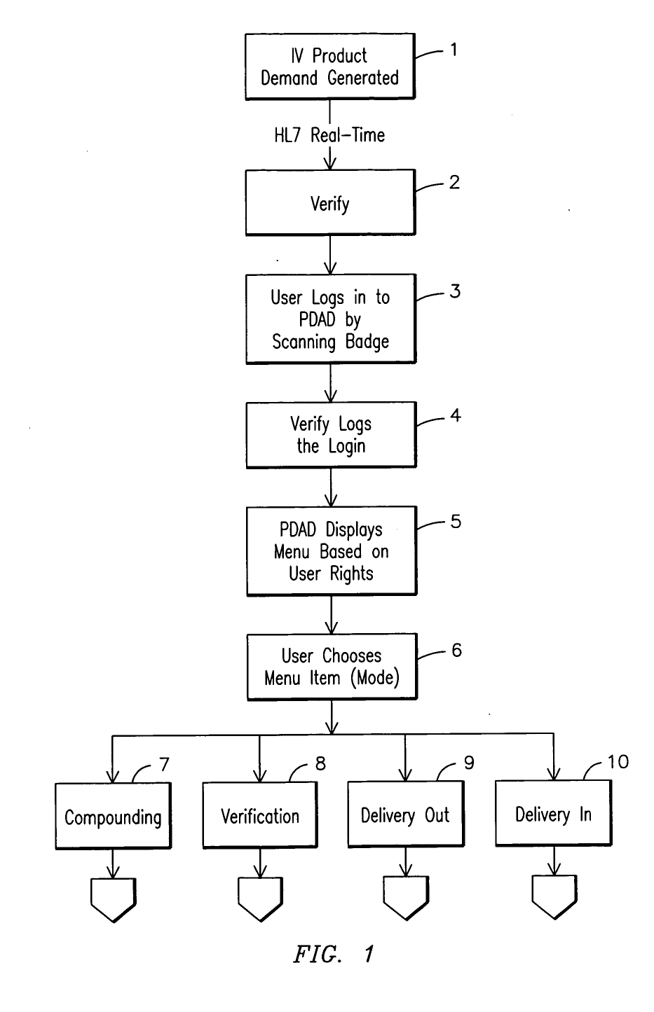

In FIG. 1, which illustrates the sign-on and mode selection phase of the invention, the admixture process all begins with the physician generating the IV product demand 1 via handwriting or by using a PDAD to enter the product demand directly into the system, in which case the system would verify 2 that the order is valid and that it is generated by an authorized and licensed physician. In any event, when a user, whether it be a physician, pharmacy technician or pharmacist, is using the system, that user must log in 3 to the PDAD manually or scanning a bar code on the user's badge identifying that user. The system logs the log-in at 4 at which time it enables certain user-defined system features for the security restrictions with which that user is associated and the PDAD displays a menu based on user rights 5. For instance, a user who is not a pharmacy technician or pharmacist would not be allowed to access the compounding or verification phases 7 and 8 of the invention, but they would only be involved in the delivery aspects, either delivery out 9 or delivery in 10, and thus would only have access to menus governing those phases.

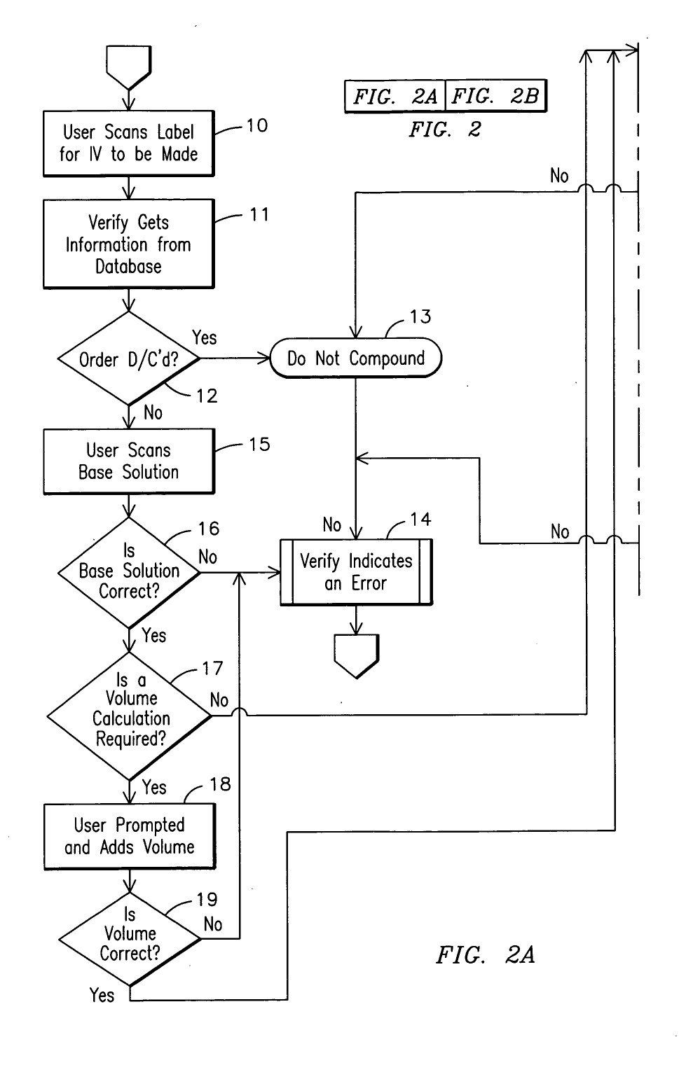

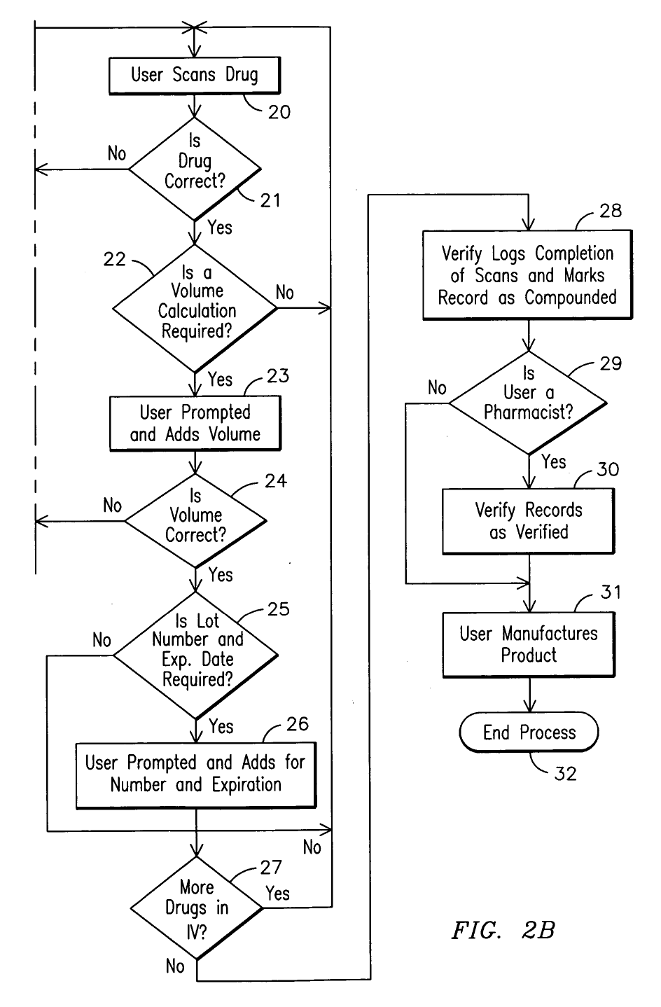

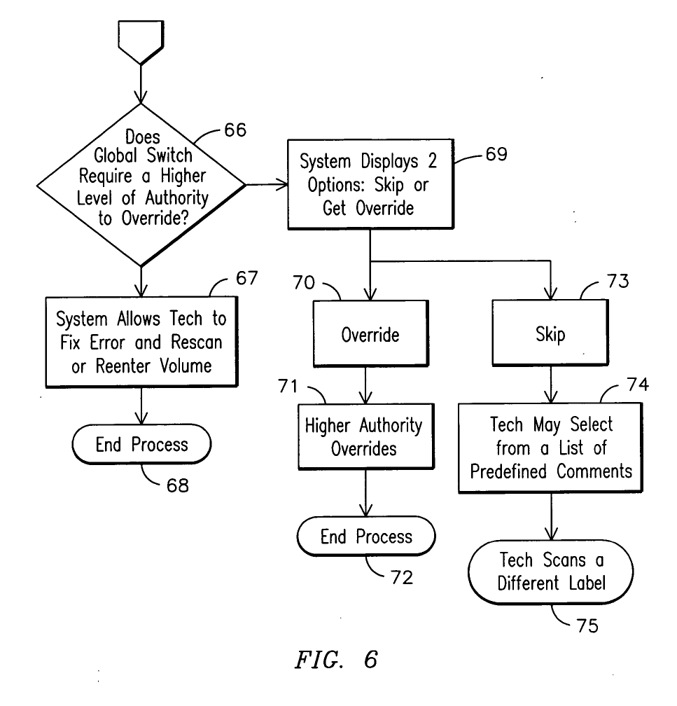

If the user chooses a menu item or mode 6 to be the compounding mode 7 the compounding phase illustrated in FIG. 2 is commenced. The user first scans the bar code on the order label generated by the pharmacy system for the IV to be made using the PDAD at 10. The bar code symbol on the order incorporates the order ID, then the order instance (i.e., first, second or third label, etc., for this order). If the bar code label is not available but the user is permitted to proceed by selecting from an on-screen list of available orders based on security access, then the order may be selected from the list. The PDAD then obtains information from a database at 11 and checks the order for validity, expiration, canceled or discontinued, and whether it is already in process or fulfilled. If the order is not valid, the technician is asked to discontinue with the label and the label is discarded and a record of the transaction is made for error processing. If the system indicates that the order is canceled or discontinued, the system advises the technician “do not compound” 13 and the system indicates an error 14 which is handled according to the process described later in more detail in relation to FIG. 6.

If the order has not been discontinued or canceled at 12, then the user scans the base solution at 15 and the system determines whether the base solution is correct 16. If the base solution is not correct, then it generates an error indication 14 and once again the technician is asked to discontinue the label, the label is discarded and a record of the transaction is made for error processing. If, on the other hand, the base solution is correct, then the system determines whether the volume calculation is required 17 and prompts the user to enter the volume used at 18. The system determines whether the volume is correct at 19 and if it is not, then indicates an error at 14 and the technician stops the order. If the volume of the base solution is correct, then the system proceeds to the next step, which is to determine whether the drugs and other ingredients being added to the base solution are appropriate.

Let's say that particular admixture calls for a certain dose of vitamins, potassium and dextrose be added. For each of these added drugs, the user scans each at 20 to determine whether the drug is correct 21. If the drug is not correct, then the technician is directed to “do not compound” 13 and is referred to an error indication at 14 for later processing. If the drug is correct, it proceeds to ask if a volume calculation is required. Then, if that is the case, the user is prompted to enter the volume used at 23 to determine whether the volume is correct at 24. If not correct, again the technician is directed to stop and proceed to error indication provided at 14 for processing. If the volume is correct, then the lot number is examined for expiration at 25. The user is prompted 26 to add the lot number and expiration date. If the lot has not expired or been recalled, then the system asks whether more drugs are required in the IV at 27.

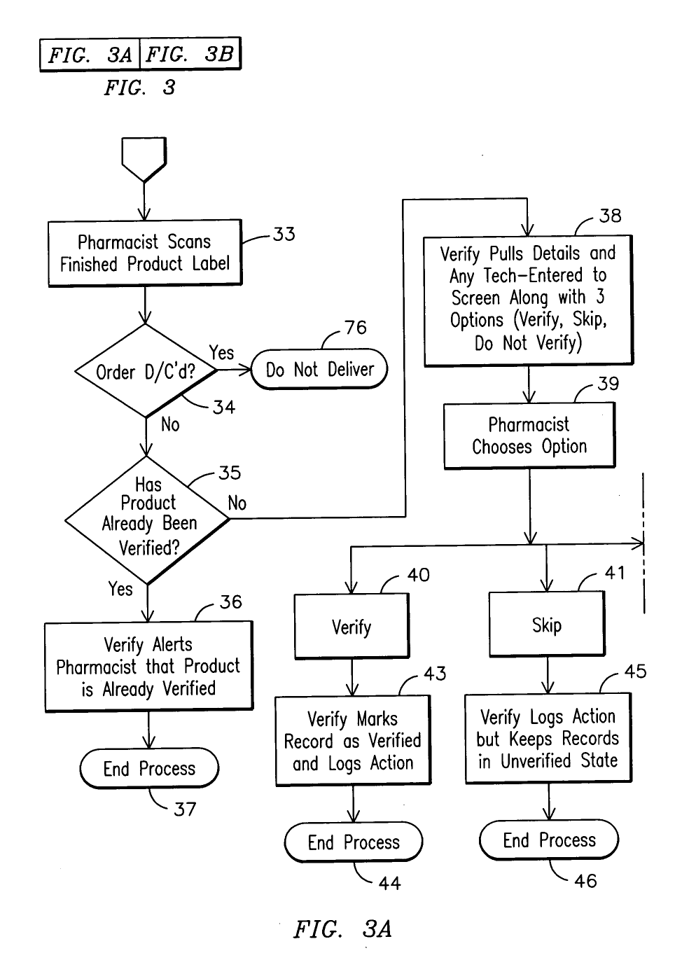

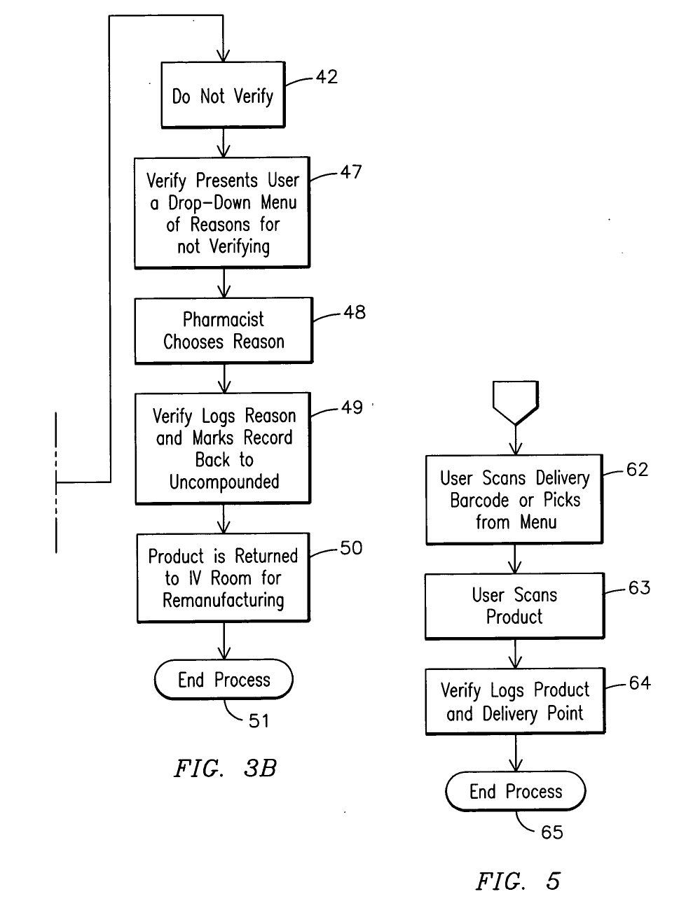

If more drugs are required, then the system repeats the same process by commencing the new drug at 20, proceeding at 27. Once all drugs in the IV have been completed, then the system requires the operator to indicate that the order is complete at 20. At 28 the user indicates the order is completed, the system checks that all items in any associated volumes are fully accounted for. If a user attempts to complete an order before all items have been addressed, the unit alarms, changes background color and highlights the missing information. If the user is unable to complete the order, then the order may be skipped or an override requested. If the user is a pharmacist 29 then other records are verified at 30, the user mixes the product 31 and the compounding process is ended 32. If the user is not a pharmacist, however, then the process must go through a verification process conducted by the pharmacist as illustrated in FIG. 3.

FIG. 3 illustrates the verification phase of the system when it is required to be accomplished by a pharmacist. In the pharmacist verification phase, the pharmacist may check a completed order using a PDAD to ensure that it has been produced correctly. First, of course, as is always required by users of the system, a pharmacist must first log in on the PDAD to access the system. Access to the system is controlled by a user-defined security group with which a pharmacist log-in ID is associated. In this phase, the pharmacist may verify completed ordered prepared by a technician. Orders already prepared by a pharmacist would have been automatically verified during product. Other details involving the production of the order are displayed for the pharmacist and any recorded notes of prior pharmacist or review actions are displayed prominently. Using the verification phase, the pharmacist may accomplish the verification either by individual order or by batch order. In either mode, the pharmacists first scan the product label at 33 and in the case of a batch order, the pharmacist would scan a number of labels in the same manner. Next, the system determines whether the order has been discontinued or canceled 34. If it has been discontinued or cancelled, then the product is removed from distribution and goes to “do not deliver” condition 76. If the order has not been discontinued or cancelled, then determination is made if the product has already been verified 35. If it has been verified, the system alerts the pharmacist that the product has already been verified at 36 and verification process is ended at 37.

If, on the other hand, it is determined that the product has not already been verified at 35, then the pharmacist pulls the details and notes entered by the technician for screening at 38. The pharmacist then has three options to choose from 39 at that point. One option is to verify 40, the second option is to skip verification 41 and the third option is to not verify 42. If the pharmacist chooses the verify option 40, then the system marks the record as being verified and logs the action 43 and the verification process is ended 44. If the pharmacist chooses the skip option 41, then the system logs the action but keeps records on verified status 45 and the process is ended 46. The order can be sent back for later review or re-manufacturing. If the order is skipped it may be reviewed later and verified. If the order is sent for re-manufacturing, it is recorded as “not acceptable” in the system. If the pharmacist selects a “do not verify” 42, then the pharmacist is presented with a drop-down menu of reasons for not verifying 47. The pharmacist may choose one of the reasons 48 and a log is made for the reason and the record is marked for the order to go back to compounding 49 and is returned to the IV room for re-manufacturing and the verification process is ended at 51.

Although not illustrated, a pharmacist may occasionally “un-verify” a previously verified order in this manner. After log-in, the pharmacist would select a menu option “un-verify” and then scan the order label or select from a list of verified orders with a user-defined prior interval. The pharmacist would confirm the “un-verifying” and also select a reason from a user pre-defined list which may be supplemented with an additional free-text entry to explain the situation.

If any order has been discontinued or canceled subsequent to production but before the pharmacist verification, this is also identified to the phamacus so the product may be removed from distribution.

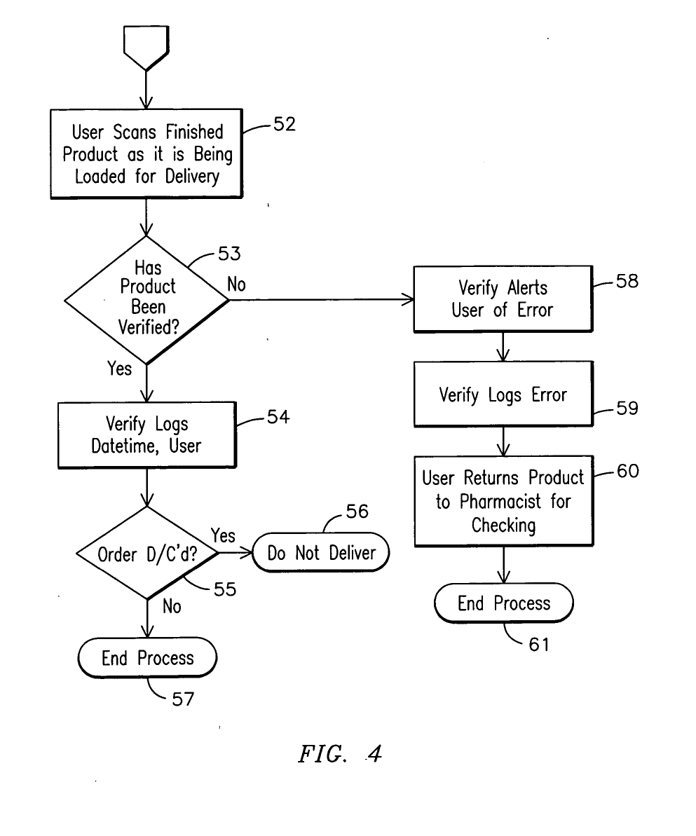

Once an order has been successfully completed, it then enters a delivery-out phase as illustrated in FIG. 4. The delivery-out phase ensures that only completed and verified orders are released from the pharmacy. When it is released from the pharmacy, the date and time the product leaves the pharmacy is recorded in the system. As in all cases, the user must log into the system with a PDAD and select the “delivery-out” option to begin the delivery-out process. Then, once in the system, the user scans the finished product has been loaded for delivery at 52. The system determines at 53 whether the product has been verified. If it has been verified, the system logs the date, time and user at 54, then it is determined whether the order has been discontinued or canceled at 55. If the order has been discontinued or canceled, the PDAD alarms and the user is prompted to remove the item from the delivery process and displays the “do not deliver” location 56. If the order has not been discontinued or canceled, then at the end-process 57, the order is deemed ready for delivery and the date and time of delivery-out is recorded.

If on the other hand, it is determined that the product has not been verified at 53, then the system alerts the user of an error at 58, at which the error is logged 59 and the user returns the product to the pharmacist at 60 and the process is ended 61.

FIG. 5 illustrates the next phase of the system where the completed verified product is delivered in to the patient. As in the other phases, the user must first log into the system at a PDAD and select the “delivery in” mode to begin the process. Then, the user scans the delivery bar code or picks from a menu 62 which selects a location from the list. The date, time the product is delivered and the delivery location is then recorded. The user then scans the product 63, the system logs the product and delivery point 64, and the product is delivered at the end of the process 65. If, however, at 64 it is determined that the order is discontinued or cancelled, the PDAD alarms and the user is prompted to remove the item from the delivery process. If the system determines the order is not verified, the PDAD alarms and refuses to continue until an override operator, as discussed herein below, acknowledges and confirms that the order has been removed from the delivery process. If it is determined at 64 that the order is at the wrong location, the PDAD alarms and the user is prompted to not deliver. An optional setting allows the user to perform the delivery regardless and the user can select a reason from a user pre-defined list why the product is delivered or not delivered.

In the event an order cannot be delivered due to an issue at the delivery location, the user records the item as returned to the pharmacy and the user can select a reason from a user pre-defined list. As mentioned previously when discussing the various phases of the present invention, sometimes it is necessary to override the system and handle errors during processing of the admixture orders.

FIG. 6 illustrates handling errors, including override of certain events in the compounding process. After scanning the order, several unexpected events may occur during processing. First, the system determines whether a higher authority is necessary to override at 66. If the user has the proper security access to override certain events, the user may proceed after an unexpected event and permission is recorded to continue after such an unexpected event. If the user has proper authority, the override may be selected to allow the user to continue with the existing order and allow the technician to fix the error and re-scan or re-enter volume in 67, which ends the process in 68. If the technician does not have the appropriate authority to fix the error, the system displays two options at 69. One option is to skip 73 and the other is to get an override 707. In the case of an override 70, the technician can obtain a person with the appropriate clearance, that is a higher authority to override at 71, in which case the override authority would scan the ID and enter a password to override the error to end the process 72. Of course, all transaction events would be recorded in the system. The other system option is to skip 73, at which a technician may select from a list of pre-defined comments 74, and scan a different label 75, the error handling system maybe used to correct issues that arise with a specific item. For instance, a user may scan an item that is not shown on the order, in which case the system would alert the user that the item is not in the order and based on the user security profile, the user may:

i. if the user has the proper override authority, acknowledge the error and scan the correct item; or

ii. if the user does not have the appropriate override authority, another user with override authority would scan the ID into the password to override the error or the order could be skipped as shown in FIG. 6.

Another issue that may arise is a user may scan an item and then enter an incorrect volume, in which case the system would alert the user that the item volume is incorrect and then, based on the user security profile, the user with the proper override authority could acknowledge the error and scan a correct item. Or, if the user doesn't have the override authority, could obtain an individual with the appropriate override authority who could do so.

Another error that could occur is if the user scans an item that enters a lot number that has been entered as “recalled”. In this situation, the system would alert the operator that the item is recalled and again, based on security profile, the user could either acknowledge the error and then enter the correct lot number or have someone with the appropriate override authority to do so.

An even further error that may occur is when a user scans an item and then enters an expiration date that is outside of a user pre-defined permissible range. In this case, the system would alert the user that the item is expired and, based on security user profile, either the user could acknowledge the error and enter a correct expiration date or someone with appropriate override authority could do so. All overrides are recorded and the user authorizing an override could record a reason from a user pre-defined list and/or supplement it with additional free text entry to further explain the situation. The admixture management system of the present invention would not only provide the above but would also generate reports on a demand basis. Access to the reports would be included in the standard security access functions of the system. The reports could be displayed on the screen, printed or extracted to standard file formats and could include pharmacy orders report, pharmacy orders production reports, open order summary report, open delivery summary reports, discrepancy reports, interface reports security group reports, authorized user reports, item master details, daily dispensing logs, overall daily drug usage, preliminary delivery locations and bar codes, etc. with custom information requested by the operator of the system.

Although only a few embodiments of the present invention have been described in detail hereinabove, all improvements and modifications to this invention within the scope or equivalents of the claims are included as part of this invention.

Having thus described my invention, I claim:

1. A system for managing the admixing of pharmaceuticals, said system comprising:
A. means for verifying the validity of an order for a pharmaceutical admixture;
B. means for verifying the accuracy of compounding the order; and
C. means for verifying the order is properly delivered to a patient.

2. The system of claim 1 further comprising after B:
means for verification by a third party after compounding the order.

3. The system of claim 1 further comprising:
a means for handling errors which may occur during the compounding process.

4. The system of claim 2 further comprising:
a means for handling errors which may occur during the compounding process.

5. The system of claim 1 further comprising:
a means for providing user security of the system.

6. The system of claim 2 further comprising:
a means for providing user security of the system.

7. The system of claim 3 further comprising:
a means for providing user security of the system.

8. The system of claim 4 further comprising:
a means for providing user security of the system.

9. The system of claim 1 wherein the means for verifying the validity of an order for a pharmaceutical admixture comprises:
a user scanning a bar code on an order label, said bar code symbol containing at least an order identification number; and
checking the order identification number with a database to determine whether the order is valid, whether it has expired, been canceled, discontinued, already in process or fulfilled.

10. The system of claim 1 wherein the means for verifying the accuracy of compounding the order comprises:
a user scanning a bar code label for an admixture to be made;
verification with a database to confirm whether an order has been discontinued or canceled and, if so, directions to “not compound” the admixture;
if an order has not been discontinued or canceled, a user scanning a bar code for a base solution for the admixture to verify that it is correct in type and in volume;
if a first drug is to be used included in the admixture, the user scans a bar code for said first drug to verify that it is correct;
if a volume calculation for said first drug is required, then the user as prompted adds the volume to determine if the volume is correct;
if a lot number and expiration date is required, then the user is prompted and adds the lot number and expiration;
if a second drug is required in the admixture, then the same process is repeated for the second drug as for the first drug;
after the scanning the bar codes for all drugs in the pharmaceutical admixture, compounding is completed; and
if a user is a pharmacist, then the user manufactures the product to fulfill the admixture order and if the user is not a pharmacist, then directions are first verified before the use of manufactured product to fulfill the admixture order.

11. The system of claim 1 wherein the means for verifying the order is properly delivered to a patient comprises:
a user scanning a bar code on the order as it is being loaded for delivery;
a verification that the order is correct or incorrect and, if correct, the order is dispatched for delivery to patient and, if not, the order is returned to the pharmacist for checking; and
at a location delivery to a patient, the user again scans a delivery bar code to determine whether the order is correct and delivery location is accurate.

12. The system of claim 2 wherein the means for verification by a third party after compounding comprises:
a pharmacist scanning a bar code label for a finished product made from the pharmaceutical admixture order;
a verification of the database as to whether the order has been discontinued or canceled, in which case it is not delivered;
if the product has not been discontinued or canceled, a determination as to whether the product has been verified and if so, it is dispatched for delivery; and
if the product has not been verified, then the pharmacist may verify the accuracy of the product, may skip verification or may choose not to verify the product, in which case the product is returned to compounding for re-manufacturing.

13. The system of claim 3 wherein the means for handling errors which may occurring the compounding process comprises:
upon indication an error has occurred in compounding, then a technician may fix the error and re-scan a bar code on a base solution or drug in the admixture and may re-enter the correct volume;
and if a user has the appropriate level of authority to override an error, the error may be overridden and the compounding continued;
or alternatively, the user may skip a particular label indicating an error and scan a bar code on a different label for use in the admixture.

14. The system of claim 5 wherein the means for providing such user security for entry into the system comprises requiring a user to log in to the system by scanning a bar code on user badge or by manually logging in on a computer using a log-in name and password.

15. A method for managing pharmaceutical admixing comprising the steps of:
A. verifying the validity of an order for a pharmaceutical admixture;
B. verifying the accuracy of compounding the order; and
C. verifying the order is properly delivered to a patient.

16. The method of claim 15 further comprising a step after Step B of:
verifying by a third party the accuracy of the compounding of the order.

17. The method of claim 15 further comprising:
handling errors which may occur during the compounding process.

18. The method of claim 16 further comprising:
handling errors which may occur during a compounding process.

19. The method of claim 15 further comprising:
providing user security for entering into the system.

20. The method of claim 16 further comprising:
providing user security for entry into the system.

21. The method of claim 17 further comprising:
providing user security for entry into the system.

22. The method of claim 18 further comprising:
providing user security for entry into the system.

23. The method of claim 15 wherein Step A comprises:
a user scanning a bar code on an order label, said bar code symbol containing at least an order identification number; and
a user checking the order with an identification number database to determine whether the order is valid, whether it has expired, been canceled, discontinued, already in process or fulfilled.

24. The method of claim 15 wherein Step B comprises:
a user scanning a bar code label for an admixture to be made;
verifying with a database to confirm whether an order has been discontinued or canceled and, if so, directing to “not compound” the admixture;
verifying if an order has not been discontinued or canceled, and user scanning a bar code for a base solution for the admixture to verify that it is correct in type and in volume;
verifying if a first drug is to be used and is included in the admixture, and the user scanning a bar code for said first drug to verify that it is correct;
verifying if a volume calculation for said first drug is required, and then the user, if prompted, adding the volume to determine if the volume is correct;
verifying if a lot number and expiration date is required, then the user, if prompted, adding the lot number and expiration date;
verifying if a second drug is required in the admixture, and then repeating the process for the second drug as for the first drug;
after the scanning the bar codes for all drugs in the pharmaceutical admixture, compounding is completed; and
if a user is a pharmacist, then the user manufactures the product to fulfill the admixture order and if the user is not a pharmacist, then directions are first verified before the use of manufactured product to fulfill the admixture order.

25. The method of claim 15 wherein Step C verifying the order is properly delivered to a patient comprises:
a user scanning the bar code on the finished product as it is being loaded for delivery;
a user verifying that the product is correct or incorrect and, if correct, the product is dispatched for delivery to patient and, if not, the order is returned to the pharmacist for checking; and
at a location delivery to a patient, the user again scanning a delivery bar code to determine whether the order is correct and delivery location is accurate.

26. The method of claim 16 wherein the step for verifying the accuracy of an admixture by a third party after compounding comprises:
a pharmacist scanning bar code label for a finished product made from the pharmaceutical admixture order;
verification of the database as to whether the order has been discontinued or canceled, in which case it is not delivered;
if the product has not been discontinued or canceled, a determination as to whether the product has been verified and if so, dispatching product for delivery; and
if the product has not been verified, then the pharmacist verifying the accuracy of the product, may skip verification or may choose not to verify the product, in which case the product is returned to compounding for re-manufacturing.

27. The method of claim 17 wherein handling errors which may occur during the compounding process comprises:
upon indication an error has occurred in compounding, a technician fixes the error and re-scans a bar code on a base solution or drug in the admixture and re-enters the correct volume; and
if a user has the appropriate level of authority to override an error, overriding the error and continuing the compounding;
or alternatively, user skipping a particular label indicating an error and scanning a bar code on a different label for use in the admixture.

28. The method of claim 19 wherein the step of providing user security for entry into the system comprises:
a user logging into the system by scanning a bar code on user badge or by manually logging in on a computer using a log-in name and password.
